(19) United States
(12) Patent Application Publication
(10) Pub. No.: US 2023/0285873 A1
(43) Pub. Date: Sep. 14, 2023

(54) UNIVERSAL ROTOR FOR ALL SYSTEMS USED TO SUBJECT FLUIDS TO CENTRIFUGAL ACCELERATIONS

(71) Applicants: François COUILLARD, Sene (FR); Jack LEGRAND, Saint-Nazaire (FR)

(72) Inventors: François COUILLARD, Sene (FR); Jack LEGRAND, Saint-Nazaire (FR)

(21) Appl. No.: 17/927,064

(22) PCT Filed: May 25, 2021
(86) PCT No.: PCT/EP2021/063872

§ 371 Date: Nov. 22, 2022

(30) Foreign Application Priority Data
Jun. 22, 2020 (FR) FR2006514

(51) Int. Cl. B01D 15/18; B01D 15/30; B01D 15/22

(52) U.S. Cl. CPC B01D 15/1892; B01D 15/30; B01D 15/22

(57) ABSTRACT

A rotor for all systems used to circulate various single-phase or multiphase fluids, ranging from organic or non-organic solvents to CO₂ in a liquid or supercritical phase in cells connected to each other by channels, the assembly being subjected to adjustable centrifugal acceleration and including precision temperature control for chemical or biochemical reactions and extractions, and purification and separation reactions and, for use in chemical and biochemical reactors. Such a rotor is formed of one or more discs stacked on top of each other, each being made up of circular sectors consisting of a circular half-sector and a circular half-sector, each being the mirror image of the other relative to the plane of the circular half-sector after they have been assembled opposite each other in a sealed manner. Their half-channels having respective links which form a link channel when the half-sectors are joined.

### CROSS-REFERENCE TO RELATED APPLICATIONS

The present application is a national phase entry of PCT application no. PCT/EP2021/063872 filed on May 25, 2021, which claims priority to French application no. 2006514 filed on Jun. 22, 2020, both of which are incorporated by reference herein.

### TECHNICAL FIELD

The present invention relates to a universal rotor for all systems requiring fluids to be subjected to centrifugal accelerations, this rotor being intended to perform any operations requiring the circulation of single-phase or multiphase fluids, for chemical and biochemical reactions, extractions, purifications or separations.

### BACKGROUND

Apparatuses consisting of reactors for performing chemical and biochemical reactions, apparatuses for carrying out extraction operations, apparatuses for carrying out purification operations, apparatuses for performing separation operations such as those performed by centrifugal partition chromatography (CPC) are well known for many years.

A first drawback of the prior art relating to operations performed by centrifugal partition chromatography (CPC), extraction operations, purification operations and separation operations is due to the actual design of the cells and linking channels connecting them in series, hollowed out in the thickness of the discs which imposes the installation of seals, generally flexible, for example Teflon®, between each disc thus closing each cell and each channel along the plane of the disc, thus perpendicular to the main axis of each cell. Even if the cell has rounded shapes to facilitate homogeneity of the dispersion for better exchange of materials between the two phases, the planes of the seals make right angles, or even acute angles with the cell, due to the elasticity of the seal that partially inserts into the cells, which is poorly conducive to a homogeneous dispersion of the liquids, and therefore is a major drawback. Finally, these flexible seal planes have, firstly, a certain porosity which leads to an adsorption of certain molecules and to a subsequent desorption, which can limit the purity of the molecules of interest. Secondly, they are subjected to continuous variations in pressure of the liquids, getting deformed over time and modifying the geometry of the cells, leading to aging of the seals, even if measures are attempted to limit this ageing.

A second disadvantage of the prior art relating to centrifugal partition chromatography (CPC) and extraction operations, purification operations and separation operations is due to the fact that the cells are interconnected by a ribbon-shaped channel. It can be readily calculated and verified that this shape of duct, for a given section, leads to a loss of pressure head which is much higher than that caused by a duct of the same cylindrical cross-section or of a very close geometry thereto. To limit too large pressures and in some cases for reasons of difficulty in machining, it becomes necessary to increase the thickness of these rectangular channels, thus increasing the excessive volumes of said channels. The latter do not participate in the separation process in which the products being separated pass but they do increase transit times by an equivalent amount, and consequently separation time and consumption of solvents.

A third drawback of the prior art relating to centrifugal partition chromatography (CPC) and relating to extraction operations, purification operations and separation operations, is due to the fact that the mass and therefore the heat capacity of the rotor discs is not favorable to precise thermal regulation and more particularly to a thermal time constant which is as short as possible, particularly during reactor operation. The temperature of the fluids passing through the cells during reactions, which may be endothermic or exothermic, can become largely detrimental to the performance or even raise safety concerns if it is not strictly controlled. A fourth drawback of the prior art relating to centrifugal partition chromatography (CPC) and relating to extraction operations, purification operations and separation operations, is due to the fact that with the rotors of the prior art, if the injected volume is increased beyond a certain value with respect to the volume of the cells, a hydraulic shock phenomenon, commonly referred to as “water hammer” can arise which partially or totally destroys the hydrodynamic balance of the first cells, propagating to the last cells of the rotor and putting an end to the manipulation.

According to the techniques used heretofore, the rotors used in centrifugal partition chromatography (CPC) apparatuses for the separation of components, comprise, in their thickness and over their entire periphery, a succession of cells arranged in series in a radial or oblique direction through a set of fine meandering ducts connected to the inlet and the outlet of each cell, the circuits of all the discs communicating with each other. Rotation of the stack creates a large centrifugal acceleration field which makes it possible for example to maintain a liquid phase, referred to as the fixed stationary phase, while a mobile phase percolates through the stationary phase in a so-called ascending mode if it is lighter than the stationary phase, or in a so-called descending mode if it is heavier. In this type of apparatus constituted by the serial interconnection of one or more strings of cells, separation is performed of the constituents of a charge in liquid solution comprising at least two components having different partition coefficients in that they are driven at unequal speeds by the mobile phase which may be either of the liquid phases.

The rotors used in these known centrifugal partition chromatography (CPC) apparatuses can be used in all applications requiring a centrifugal acceleration field and very good thermal regulation, among other things to perform purifications, separations and extractions with conventional solvents but particularly with CO₂ in liquid or supercritical phase in centrifugal partition chromatography (CPC), these being techniques in which molecules are purified and/or separated between two liquid phases, taking place in each cell, with mass transfer being promoted by good dispersion of the mobile phase arriving through the inlet channel of each cell. When it is desired to construct an industrial production apparatus, a person skilled in the art knows how to scale up from separations performed on a laboratory apparatus, i.e. the number of cells, the volume of said cells, the flow rates of the mobile phase, the hydrostatic pressure generated, etc. Nevertheless, as these parameters are relatively numerous and of necessity are subject to errors, the apparatus will operate, but will not be exactly at its optimum or modifiable simply with the technologies of the prior art.

The prior art apparatuses consist of rotors whose number and volume of the cells are defined before their construction and are not modifiable thereafter, which rules out possibilities of optimization for the various applications which may be present. To simplify things, we shall stick to the field of CPC separation, namely: if a user has a rotor of the prior art made up of 500 cells and it is desired to perform a given separation for which the optimum is 500 cells, everything will run smoothly. However, for another separation where 1000 cells would be required, said separation will only be partially resolved. Conversely, in the case of another separation to be performed with this same rotor having 500 cells, while a rotor having 200 would be the optimum, the duration of the separation will be multiplied by around 2.5 which results in a loss of time, increased solvent consumption and a reduction in productivity in the same ratio.

The present invention intrinsically provides, as regards the rotors used for separation, more particularly in centrifugal partition chromatography (CPC), significant advantages over known centrifugal partition chromatography (CPC) apparatuses, not only thanks to their duality of use, but also to their ease of use and ease of adaptation to particular operating conditions. The present invention provides a universal rotor making it possible:
firstly, to separate one or more components having different partition coefficients from liquid mixtures, and
secondly, to perform chemical reactions between several components.

The rotors according to the invention can also be applied to the two implementations mentioned above successively, namely a reaction between two or more compounds, followed by a separation of the desired product in the reaction mixture resulting from the chemical reaction or a separation of a component contained in a mixture followed by a chemical reaction of the component obtained with another product. The present invention can therefore be considered for each of these two applications and for successive use of the two applications.

### SUMMARY

The present invention provides a universal rotor for operations requiring fluids to be subjected to centrifugal accelerations in the context of operations requiring the circulation of single-phase or multiphase fluids, for chemical and biochemical reactions operating in particular continuously, purifications, extractions, separations, centrifugal partition chromatography (CPC), liquid-liquid extractions among others. The rotor according to the invention is capable of being implemented as chemical and/or biochemical reactors, liquid-liquid extractors, in purification operations, centrifugal partition chromatographs (CPC), among others. The liquid or solvent phases may comprise, among other things, organic solvents, ionic solvents, NADES (natural deep eutectic solvents), CO₂ in liquid or supercritical phase circulating in cells connected to each other by channels, and being applied, in different fields, such as those of chemical and biochemical reactions, of extraction, of purification, of separation.

The present invention provides a universal rotor for operations requiring fluids to be subjected to centrifugal accelerations involving the circulation of single-phase or multiphase fluids, for treatments consisting of purifications, extractions, separations, centrifugal partition chromatography (CPC), liquid-liquid extractions, chemical and biochemical reactions, wherein:
the rotor is formed of a disc or a plurality of discs stacked one on top of the other,
each of said discs consists of a retainer in which a ring (A1) consisting of the assembly of one or more circular sectors is inserted,
in the case of a single circular sector, a space is provided between the two ends of the single circular sector.
in the case of several circular sectors, the space is arranged between the ends of two contiguous circular sectors.
a linking connector is inserted into said space,
the linking connector has branching means consisting of channels necessary for a liquid phase entering through inlets into said linking connector to be guided to travel through a network of cells up to outlets of said linking connector, said outlets being in direct contact with inlets of a linking connector of a next disc and so on up to an outlet of a last disc which is connected to an outlet of said rotor.

According to one embodiment of the invention, the rotor is formed by a single circular sector comprising a network of successive cells interconnected by channels both arranged in a plane approximately at a midpoint of its thickness, characterized in that there is at least one gap between its two ends for arranging a linking connector in a sealed manner, said linking connector comprising at least one inlet and at least one outlet intended to respectively allow entry of a liquid mixture into said network of cells and the exit of said mixture from the network of cells. According to another embodiment of the invention, the circular sectors are made from two circular half-sectors, each of which is the mirror image of the other, both comprising on their mirror plane, half-cells and half-channels, the two half-sectors being assembled in a sealed manner, preferably by diffusion welding, face-to-face, to become a circular sector.

According to yet another embodiment of the invention, the circular sectors are preferably made in one piece, for example directly by additive construction. According to yet another embodiment of the invention, the single circular sector comprises, in its thickness, one or more ducts having a generally rectangular cross-section each arranged in a circular pattern, typically three, delimited by concentric walls and arranged such that an average radius of each of said ducts arranged in a circular pattern substantially corresponds to a respective same mean radius of a corresponding network of cells arranged in a circular pattern, for circulating a temperature control or thermostatting fluid in said ducts in a fashion that is as identical as possible for each network of cells.

According to one embodiment of the invention, the linking connector comprises the necessary branches so that the temperature control fluid or thermostatting fluid entering passes through all the ducts connected in series of each one of the circular sectors constituting a said ring, and then guided by said linking connector, passes to the linking connector of a next disc in order to pass in the same way through the ducts connected in series, and continuing in this way up to the outlet of the rotor. According to yet another embodiment of the invention, said linking connector also includes an inlet and an outlet allowing entry and exit of a temperature control or thermostatting fluid in order for it to pass through the at least one temperature control or thermostatting fluid duct.

According to one embodiment of the invention, the cells and channels have walls as thin as possible, and are provided with fins, said fins being themselves integral with the internal walls of the circular sector. According to another embodiment of the invention, the linking connector comprises at least one inlet and at least one outlet for respectively allowing entry of a liquid mixture into the networks of cells and the exit of said mixture from the networks of cells, such that between the outlet and the inlet, the liquid phase passes through all the cells and channels of a respective disc.

According to yet another embodiment of the invention, linking connector (B6) can be installed in place of linking connector (A6), in which case a single or multi-way ball valve comprising “ON” and “BYPASS” positions is added thereto, making it possible to select positions such that in the “ON” position of said valve a liquid phase entering at (31) is directed at (32) of said valve to then enter the inlet (13) of a contiguous circular sector in order to traverse the entire network of cells of a disc and arrive at (14) of the last circular sector and then to (35) and then to (36) of the linking connector, to enter the next contiguous disc at (31) of the linking connector thereof but, if the ball of said valve (42) is in the “BYPASS” position, the liquid phase entering at (31) is directed directly to (36) without traversing the cells of the disc concerned, the latter being short-circuited, allowing the user to adjust the number of cells to each of its various applications in steps by the number of cells contained in a disc.

According to yet another embodiment of the invention, each circular sector of a ring is formed of two superimposed circular half-sectors, face-to-face, or of a stack of such superpositions, each of these half-sectors comprising half-cells whose angles (20) are replaced by chamfers forming rounded surfaces. According to another embodiment of the invention, in order to increase the productivity of said rotor, in the CPC mode, in the ascending mode, the “n” first cells of said rotor have decreasing volumes according to a determinable function ranging from (V7) to (V) with (V7>V), V being the constant volume of the majority of the cells of said rotor.

The present invention also relates to the use of the universal rotor in operations requiring fluids to be subjected to centrifugal accelerations in the context of operations requiring the circulation of single-phase or multiphase fluids, for purifications, extractions, separations, centrifugal partition chromatography (CPC), liquid-liquid extractions. The present invention also relates to the use of the universal rotor in operations requiring fluids to be subjected to centrifugal accelerations in the context of operations requiring the circulation of single-phase or multiphase fluids, for chemical and/or biochemical reactions. The invention will be better understood on reading the following description of preferred embodiments, given as a simple, non-limiting example, and accompanied by the following drawings.

### BRIEF DESCRIPTION OF THE DRAWINGS

FIG. 1 schematically shows, in exploded view, a ring A1 consisting of four circular sectors 2 to 5 and a linking connector 6 according to the invention.

FIG. 2 is a schematic representation in exploded view, of a ring A1 inserted in a centering retainer with an axis 8 in order to form a disc A2.

FIG. 3 is a schematic representation in exploded view of an example of a circular sector A3 consisting of an assembly of two circular half-sectors 10 and 11 forming a circular sector according to the invention.

FIG. 4 is a schematic representation of an example of a static linking connector A6 contiguous to two circular sectors having two networks of cells of different volumes, as well as a path 37-38 for the circulation of a fluid for controlling the temperature in the rotor according to the invention.

FIG. 5 is a schematic representation of another example of a linking connector B6 with a two-position valve contiguous to two circular sectors having two networks of cells of different volumes, as well as a pathway for the circulation of a temperature control fluid for the temperature of the rotor according to the invention.

FIG. 6A is a schematic representation showing three cross-sections of an example of a rotor according to an embodiment of the invention, limited to 6 discs so as not to encumber the figure showing in detail the various fluid paths of the mobile and thermal phases.

FIG. 6B is a schematic cross-sectional representation of two two-position valves installed in the linking connector in a plane perpendicular to their axis and passing through one of the distribution channels.

FIG. 7 is a schematic representation of an example of the construction of a rotor mounted on a vertical axis according to one embodiment of the invention.

FIG. 8 is a schematic representation of an example illustrating the possibility of simply adding or removing discs to and from the rotor according to the invention in order to adapt its geometry to various applications, to perform after-sale servicing or for any other reasons.

FIG. 9 is a schematic representation of an example of arrangements of the cells in a CPC rotor making it possible to increase injectable volume.

### DETAILED DESCRIPTION OF EMBODIMENTS

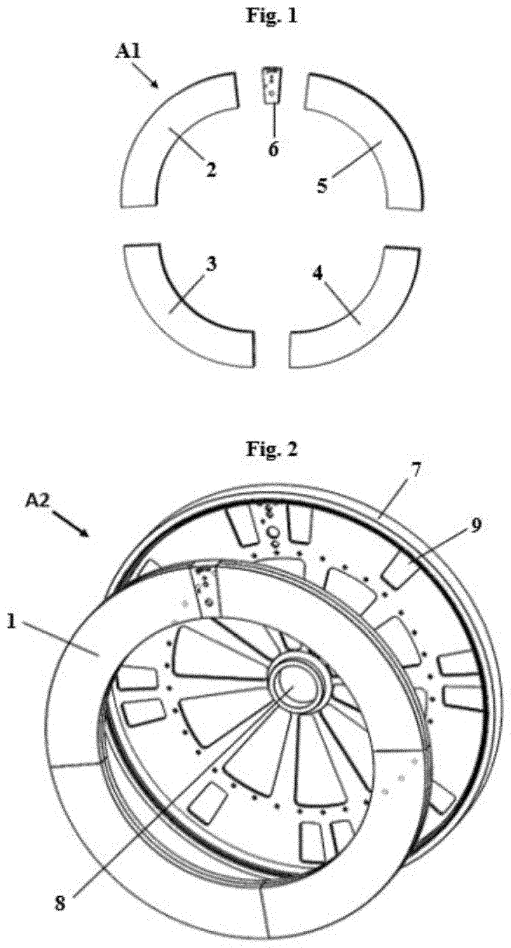

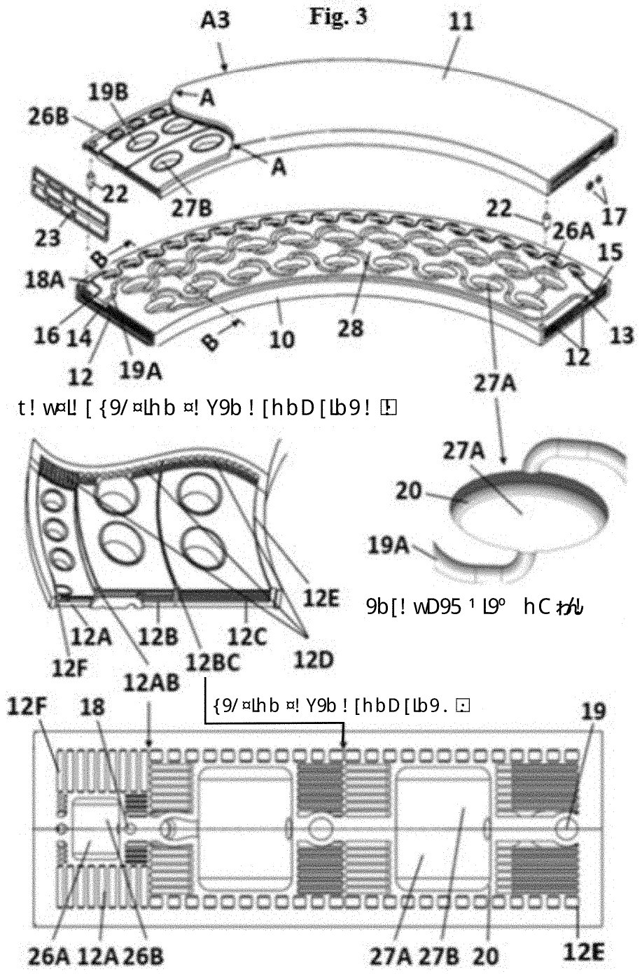

FIG. 1 shows an example of a ring A1 consisting of four circular sectors 2, 3, 4, 5 and a linking connector 6 of a rotor according to the invention. FIGS. 2, 3, 4, 5 and 6 described in greater detail below show one or more concentric networks of cells formed on the surface of circular semi-sectors, their face-to-face assembly forming a circular sector A3. These cells are interconnected in series by channels, see FIG. 3.

The ring A1 shown in FIG. 1 comprises a set of open circular sectors 2 to 5 each having two ends and comprising at least one network of cells concentric with the axis of said circular sector, formed on a plane at about the mid-point of its thickness. In the example shown in FIG. 1, ring A1 is formed of a plurality of distinct circular sectors 2 to 6, more precisely four distinct circular sectors 2 to 5, each comprising a portion of the network or networks of cells which are assembled pairwise in a sealed manner so as to ensure continuity of the network of cells, connected to a linking connector 6, which will be described in more detail below. The number of circular sectors may of course vary. In particular, the apparatus may very well include a single circular sector which then comprises all the cell network or networks of the ring A1.

In the case of several circular sectors 2 to 5, the two ends of the circular sectors 2 and 5 correspond to one end of a first circular sector 2 which is not connected to another circular sector, and to one end of a last circular sector 5 also not connected to another circular sector. In the case of a single circular sector, its two ends correspond to those of an assembly of several circular sectors.

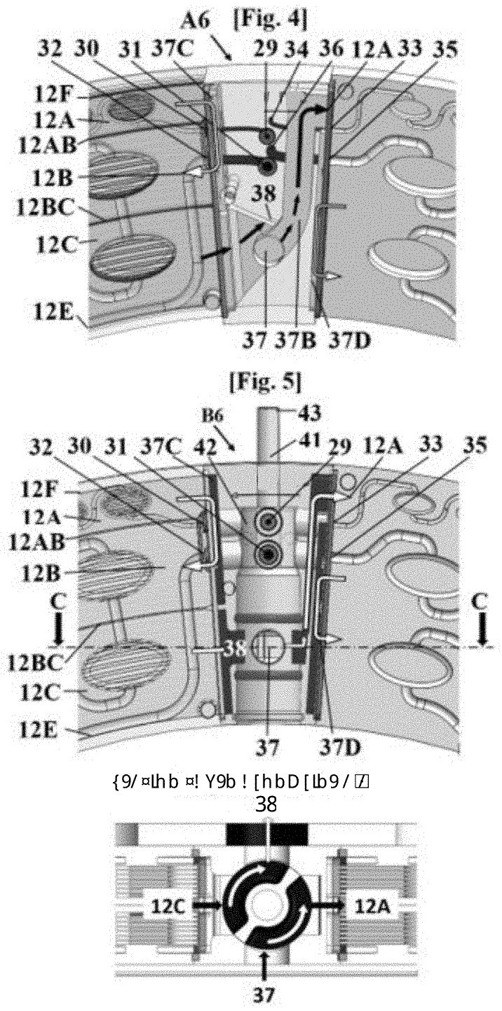

A linking connector 6 is interposed in a sealed manner between the two ends of the assembly of the circular sectors 2 to 5. This linking connector makes it possible, in one embodiment of the invention, to allow the mobile phase and the sample to be injected to enter into the ring A1, and then after they have passed through all the cells, to direct them into a linking connector of an adjacent ring which in turn performs the same function, and so on up to the last ring of a rotor constituted by a stack of discs. The various components of the sample entrained by the mobile phase, in the case of a CPC separation application for example, are separated during the course of their path through the cells and channels, and then are detected and/or collected by one of the well-known means used in liquid/liquid centrifugal partition chromatography CPC or for applications performed in other fields. The linking connector may have other functions according to the invention which will be presented in the detailed description of FIGS. 4 and 5.

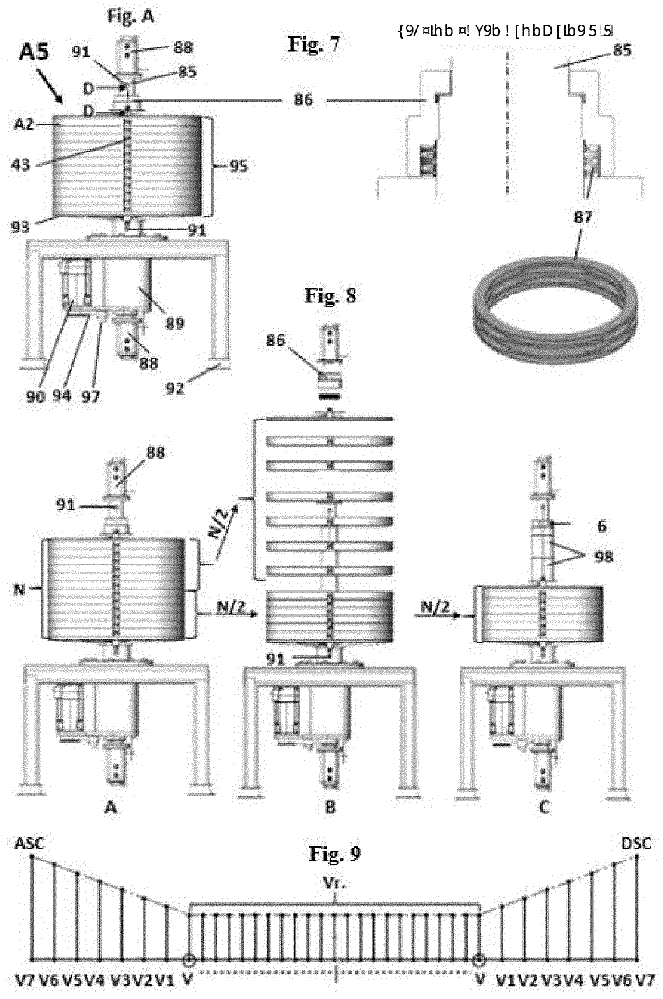

FIG. 2 shows, in an exploded view, a non-limiting embodiment of the assembly of the ring A1 in a support or centering retainer in order to form a rotor disc A2. Mechanical tolerances between the inner diameter of the centering retainer and the outer diameter of the ring A1 must be such that the ring A1 is tightly clamped by the centering retainer 7 in order to ensure good mechanical strength and good sealing between the various component parts making up ring A1. The insertion operation can be, for example, be carried out by a method of thermal expansion by temperature difference between the two parts to be assembled. Openings 9 are arranged on the plane of the centering retainer in order to make extraction of ring A1 possible using a press. The central bore 8 of the centering retainer is a sliding fit with a minimum of play on a rotor shaft 85 for optimal centering and allow it to slide on said shaft of said rotor, see FIGS. 7 and 8. Each rotor disc A2, previously filled with liquid, is statically and dynamically balanced up to accelerations slightly greater than the maximum intended acceleration when the apparatus is designed.

FIG. 3 shows, in an exploded view, a circular sector A3 according to one embodiment of the invention, consisting of a first circular half-sector 10 and a second circular half-sector 11, each being the mirror image of the other with respect to the plane 28 of said circular half-sector 10; after their assembly face to face in a leakproof manner the result is a circular sector A3. In the present embodiment of the invention, a circular sector comprises two networks of twenty cells each, one of which consists of cells 26 of volume V and the other of cells 27 of volume 8V. For a better understanding of the drawings, it will be noted, for example, that a cell 27 consists of the assembly of a first half-cell 27A formed on first circular half-sector 10 and of a second half-cell 27B formed on second circular half-sector 11. The same applies to the channels. Said half-cells are not necessarily the image of one another because they can be dissymmetrical, provided that at the contact plane 28 between the two half-sectors, they strictly have the same profile.

Their respective channels 18 and 19 linking the cells, see the section taken along line B-B of FIG. 3, have cross-sections adapted to the necessary flow rates required for the operation of the cells. The two circular half-sectors are positioned facing each other as accurately as possible, being located for example by two lugs 22 inserted with an interference fit into two cylindrical holes of circular half-sector 10. In the second mirror circular half-sector 11, two holes for a sliding fit are formed, one of which is cylindrical and the other oblong corresponding to the positions of the lugs inserted into the circular half-sector 10 in order to perform unconstrained assembly of the two circular half-sectors, for example by diffusion welding. Preferably, lugs made of the same material grade as that used for the manufacture of the circular half sectors, or a material having a thermal expansion coefficient as close as possible thereto, are used in order to prevent any mechanical stresses from causing deformations due to thermal expansions during the welding operation. Entry of the mobile phase and the sample, when operating in descending mode into a circular sector A3, takes place via inlets 13 or 15 and through inter-sector seals or gaskets 17 corresponding to the selected cell network. The corresponding outlets are respectively 14 and 16. Gasket 23 forms a seal between the circular sectors and linking connector 6 for the possible circulation of a thermal fluid inside, see reference numeral 12, of the two circular half-sectors which in this particular embodiment takes place in three separate ducts 12A, 12B and 12C, separated by walls 12F, 12AB, 12BC and 12D, the pattern of each having the same center respectively as one of the three networks of cells arranged in a circular pattern. These cells have thin walls and are equipped with fins, which makes it possible to reduce thermal resistance between the temperature control or thermostatting fluid and the liquid phases passing through the cells and channels, while increasing the mechanical strength of said cells, by their mutually perpendicular arrangements.

According to the invention, rounded surfaces or chamfers 20 are made, shown in detail in the enlarged view of half-cell 27A, instead of cells having sharp corners, these latter considerably degrading hydrodynamic operation and consequently performance of the apparatus. This manner can be advantageously applied to all conceivable geometries of cells, whether they are symmetrical or dissymmetrical and whatever their various applications. The channels 18 and 19 linking the cells are advantageously circular in cross-cross-section, also for good hydrodynamic operation. However, in the case of conventional mechanical machining of said channels, it will be possible for reasons of ease of machining and/or state of their surface, to give them a polygonal cross-section, for example square, taking care to round all the angles in order to obtain a cross-section closest to a circular cross-section.

FIG. 4 shows an embodiment of the linking connector having a fixed configuration, in this instance the fixed configuration connector A6, comprising one or more inlets 29 to 31 for the liquid phases and corresponding outlets 30 to 32, respectively connected in descending mode to ports 15 and 13 of a circular sector A3 which is contiguous to the linking connector. The mobile phase passing through the network of the selected cells 26 or 27 and the channels 18 or 19 linking them of said circular sector, exiting at ports 16 or 14, are connected to the inlets 15 and 13 of the next circular sector, and so on up to the last circular sector of the ring contiguous to the second end of the linking connector, the mobile phase entering at ports 33 or 35 to emerge through ports 34 or 36 of the linking connector and entering, at ports 29 or 31, the adjacent linking connector of the next disc and proceeding in this way from disc to disc up to the last disc of the rotor, the outlets 34 or 36 being connected to the outlets 54 or 56 of the rotor. When the inlet/outlet of a network of cells is selected, it is recommended to seal the other network by two stoppers at the flanges of the rotor, in order to avoid any loss of liquid phase during operation, which could result in a dynamic imbalance of the rotor in rotation.

To aid understanding, the linking connectors A6 and B6, FIGS. 4 and 5 between two circular sectors have been illustrated, the circular sector at the left being semi-transparent to better explain the exemplary embodiment, here with fins and concentric walls 12AB and 12BC, the circular sector placed on the right not being transparent to show the connections between the linking connectors and the networks of channels and cells of circular sectors A3, (2 and 5).

Said linking connector A6 or B6 FIGS. 3, 4 and 5 and cross-section taken along line C-C comprises an inlet 37 for injecting the temperature control or thermostatting fluid which is guided by the channel 37B into a duct 12A of the first circular sector, which is delimited by the concentric walls 12F and 12AB, then passing through said channel of successive circular sectors up to the linking connector, passes into channel 37C of said linking connector and then enters the duct 12B, delimited by the walls 12AB and 12 BC passing therethrough up to the linking connector which leads it via its channel 37D to the inlet of the duct 12C delimited by the concentric walls 12BC and 12E, passing through said duct up to the linking connector and exiting through a connection 38 which is arranged on the same axis as inlet 37 and on the opposite end which is adjacent to the inlet 38 of the linking connector of the next disc in the stack proceeding through the stack until it reaches the outlet of the last rotor disc which leads the temperature control or thermostatting fluid to the outlets 58 or 59.

FIG. 5 shows a second major embodiment according to the invention of linking connector 6, in this instance B6. It has all the same functions as those of linking connector A6 of FIG. 4 and bears the same reference numerals, but incorporates a valve 42, for example of the ball valve type 41 having two positions, Run and Bypass. In the Run position, the mobile phase enters the linking connector through ports 29 or 31 to be led by the valve at ports 30 or 32 to enter via port 15 or 13 (FIG. 3) the first contiguous circular sector, then through the entire selected network of the disc to the inlets 33 or 35 and to the outlets 34 or 36 of the circular sector and then entering the adjacent linking connector of the next disc.

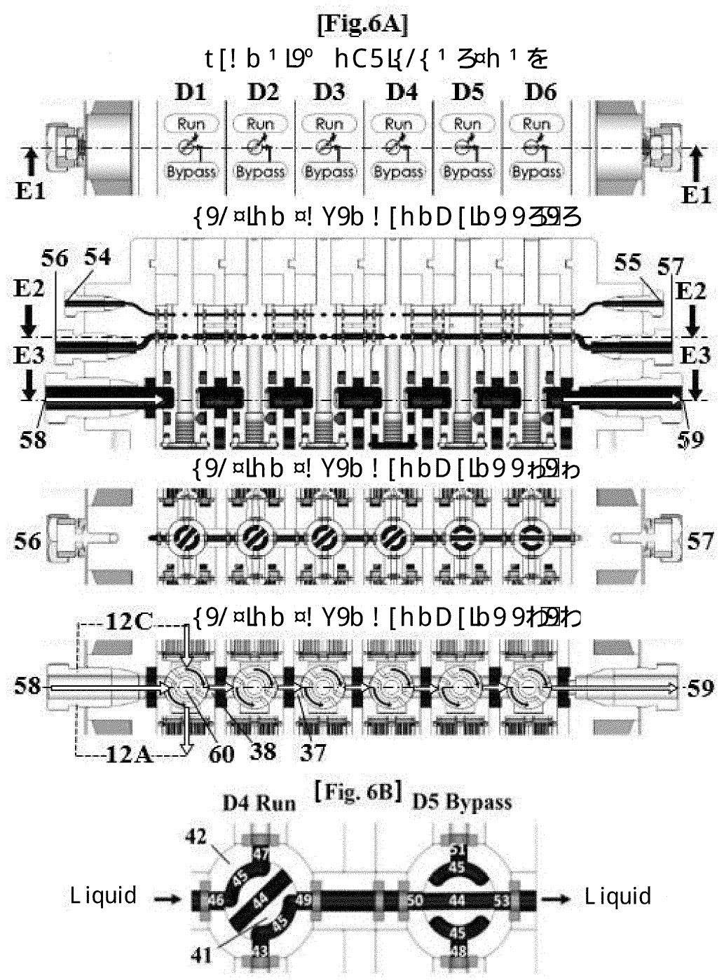

In the Bypass position, the mobile phase which had previously filled the cell network concerned is trapped therein. The mobile phase entering at ports 29 or 31 of the said linking connector is directed directly by the ball valve towards the outlet 34 or 36 of the linking connector adjacent to the next linking connector of the stack. This embodiment makes it possible for the user, by turning the ball valve 41 one quarter of a turn in one direction or the other by means of a screwdriver introduced into slot 43, to adjust the number of active cells of the rotor in steps corresponding to the number of cells contained in a disc. The operation of this major embodiment of the invention is shown more in detail in the following discussion of FIGS. 6A and 6B.

FIG. 6A shows a top view of the rotor according to the invention showing the disc selection valves and then in three cross-sectional views along E1-E1, E2-E2 and E3-E3 as a non-limiting example a rotor according to the invention, formed only of 6 discs DI, D2, D3, D4, D5 and D6, so as not to overload the figure. By way of non-limiting example, the disc discussed here comprises two concentric independent networks of 80 cells, each of the two networks consisting of cells of different volumes and of linking channels, the respective cross-sections of which are adapted to the flow rates necessary for said cells. By way of non-limiting example, the small cells have, in the present example, a volume V and the other cells have a volume of 8V.

The linking connectors 6, whether they are of fixed configuration A6 of FIG. 4 or associated with a switching valve B6 of FIG. 5, are directly interchangeable. Cross-section E1-E1 is taken along a cutting plane defined by a generatrix of the rotor intersecting the axes of the valves 41 and the axis of the rotor. Cross-section E2-E2 is taken along a cutting plane perpendicular to cut E1-E1, passing through the axis of the channels passing through the switching valves hydraulically connected to the inlets and outlets 56 and 57 and/or 54 and 57 according to the network used. Cross-section E3-E3 is taken along a cutting plane perpendicular to cut E1-E1 and passing through the axis of the inlets and outlets 58 and 59 of the temperature control or thermostatting fluid.

Cross-section E1-E1 is an assembly view including the double-channel ball valves adapted to the two networks of cells of different volumes V and 8V of the present embodiment. For its use, the network corresponding to the volume of the selected cells is selected by connecting, for example, the arrival of the mobile phase in descending mode to the inlet 56, outlet 57 then being that of the rotor which will be connected to a detector and to a fraction collector, for example. It is recommended to connect a plug at ports 54 and 55, to prevent the phase in the corresponding cell network from escaping, so as not to risk a dynamic imbalance of the rotor when rotating. Cross-section E1-E1 also shows the inlet and outlet 58 and 59 intended for the circulation of a liquid for controlling temperature or a thermostatting fluid for the rotor.

Cross-section E2-E2 more precisely shows the hydraulic operation of the valves “RUN”-“BYPASS” showing, on a larger scale in FIG. 6B, those installed on the discs D4 and D5. It is observed that the ball valves 41 of the rotor discs are arbitrarily positioned to “RUN” as regards discs DI, D2, D3, and D4 and to “BYPASS” regarding discs D5 and D6 just by way of example illustrating operation according to the invention in which it is desired to use only 4 active cell discs, or 320 active cells out of the 480 of the present rotor.

The cross-section E3-E3 shows the plane parallel to cross-section E2-E2 and passing through the axis of the connectors 58-59. The temperature control liquid or thermostatting fluid enters, for example by the connector 58, then arrives at the inlet 37 of the first linking connector A6 or B6. A diverter 60 directs it in the direction of the arrows towards the temperature control liquid or thermostatting control channel 12A of the contiguous circular sector. After the temperature control liquid or thermostatting fluid has passed through all the ducts 12A, 12B to 12C of the circular sectors of the disc, it arrives at duct 12C to be directed at port 38 of diverter 60 of the linking connector and directly passes from outlet 38 to the inlet 37 of the adjacent linking connector of the next disc until it arrives at the outlet 59 of the rotor.

FIG. 6B shows in detail the path of the mobile phase from the outlet 34 or 36 of disc D3. It enters at port 46 from the valve of disc D4 positioned to “RUN”, then is directed by passage 45 to port 47 at the inlet of the cell network of disc D4, then exits at port 43. It travels through channel 45, arriving at port 49, passes through the connection 49/50, and then straight though the channel of ball 44 of valve D5 in the “BYPASS” position, in order to exit directly at port 53, said outlet being connected to the inlet, 29 or 31, of the linking connector of the adjacent disc D6, which as it also is in the “BYPASS” position, leads it directly to the outlet 55 or 57 of the rotor.

In this example, the mobile phase thus passes through 320 cells of the rotor that comprises 480. It is possible to produce rotors with many more cells to widen the field of applications. It can be seen, for example, that the number of cells used in such a rotor can be modified by a number of cells corresponding to the number of cells contained in each disc, by performing a quarter turn of the balls 41 of valves 42 and thus making it possible to operate with 80, 160, 240, 320 or 400 cells of such a rotor, depending on the requirements of the separations to be performed. If the light mobile phase is connected to inlet 57, the path in the networks of cells remains the same but in ascending mode.

FIG. 7 shows an embodiment of the invention in which the rotor is formed by a stack 95 of discs A2, and in which the rotor shaft 85 is at one end thereof maintained upright by a suitable assembly arranged in a cylinder 89. A motor 90 provided with a toothed pulley rotationally drives said rotor, the axis of which is also provided with a toothed pulley, the two toothed pulleys being mechanically coupled by a toothed belt 94 held under tension by an eccentric tensioner 97. Each end of shaft 85 is equipped with a hydraulic rotary seal 88 which makes it possible for the mobile phase and the temperature control or thermostatting fluid to enter and exit the rotor without some being retained.

These rotary seals must be adapted to the pressures and speeds of rotation involved and must be of easy access in order to simplify maintenance, cleaning, changes in seals, after-sales servicing, etc. A nut 86 having a bore for receiving a spring 87 is threaded onto rotor shaft 85 so that the spring 87 provides sufficient permanent pressure to ensure sealing of all the seals of the discs of the stack constituting the rotor and so that the assembly is mechanically homogeneous and stable. The frame carrying this mechanical assembly is fixed to the apparatus by dampers 92 provided for this purpose, to which safety fasteners are added along with mechanical locking means for transport, complying with applicable standards.

FIG. 8 shows in detail an example of a non-limiting embodiment according to the invention of a rotor, for example from production, consisting of a stack or superposition of 12 discs A2, illustrating the ease with which it is possible to modify the number of discs of said rotor, and which has proved particularly applicable to production apparatuses. As the latter operate frequently long term on a same application, they do not necessarily need to be optimized frequently. However, the embodiment of the invention comprising a “RUN-BYPASS” valve installed on each disc of the rotor can prove very effective if the objective of the apparatus considered is to perform various operations on demand, in synthesis, purification, extraction, etc. The user can quickly optimize the apparatus closest to the optimum, using said valves 42 for each one of its various applications.

For the calculation and construction of a production apparatus intended to carry out a given application long term, calculations and experiments for scale change, derived from results of measurements performed on laboratory devices, preferably equipped with “RUN-BYPASS” valves on each disc according to the invention, should save on time and precision. However, measurements may be somewhat affected by error, an industrial rotor constructed on these bases may not be exactly at its optimum, a defect that can be easily corrected by the technological flexibility of the invention, because it is possible to add or remove one or more discs making it possible to optimize performance under actual conditions and by adjusting the number of cells necessary, this operation being simplified by the construction of the discs using assembly of circular sectors, said circular sectors being able to have more or fewer cells on demand.

View A of FIG. 8 shows a rotor A5 consisting of twelve discs according to the invention and which all have been previously and independently balanced. Suppose it is desired, for any reason, to remove one or more discs, let us suppose 6. To do this, the upper rotary seal 88 is removed and the nut 86 and the connection tubes 91 are unscrewed and spring 87 is removed. It will be seen from FIGS. 8A and 8B that the flange 93 can be removed and then the 6 discs one by one, see FIG. 8B, to arrive at FIG. 8C in which the rotor consisting of the flange 93 placed on the stack which now consists of six discs, then the spacers 98 sliding on the shaft, the lengths of which will preferably be in binary progression so as to limit their number, the smallest spacer having a height equal to the thickness of a disc, then the nut 86 and then rotary seal 88.

This embodiment presented with a vertical axis does not exclude an assembly made with a horizontal or articulated axis of rotation allowing the portion supporting the rotor to be angularly displaced. A person skilled in the art will know the use of various means known in conventional mechanics in order to put such a mounting into practice.

FIG. 9 shows a non-limiting example of another embodiment of the invention making it possible to increase the injectable quantity of sample to be treated with a rotor in CPC operation, consisting of a set of identical cells of the same volume V. Preceding the inlet to said rotor, when it is desired to operate in ascending mode ASC, a network of cells whose volumes have progressive values are added and, in order to simplify description, the first one V7 has a volume n times greater than the volume V of the cells of the rotor. Between V7 and the first cell V of the network of identical cells, a number of cells V6, V5, . . . V1, according to a law of variation of the volumes to be determined are interleaved. In FIG. 9, for the sake of simplification, this variation is presented in a non-limiting manner according to a linear function. The same applies when operating in descending mode DSC in which the same values of the volumes of the cells are represented by way of example.

It is useful to employ discs equipped with a valve 42 according to the invention making it possible to connect or not, all or parts of the discs of the rotor comprising the networks of cells of different volumes in order to adjust the number as a function of the needs of each application. The rotor according to the invention is used in centrifugal partition chromatography CPC operations allowing the separation of a compound contained in a solution formed from several components. The separation of the sample is based on the partition coefficients specific to each of the components of the sample between the mobile and stationary phases. The partition coefficient determines the affinity of each molecule in the mobile and stationary phases and therefore the speed at which each molecule moves in the system. At the end of the purification process, automated fraction collectors retain all the selected fractions according to the parameters of the program.

The rotor according to the invention can be used not only in separation operations, but also for reaction operations between components, thus acting as an intensified chemical and/or biochemical reactor due to the excellent mixing occurring in each of the cells. The advantage of the system is that of obtaining a plug flow reactor-like behavior, which is recognized to give the best performance, considering said universal rotor as a succession of perfectly stirred reactors, consisting of the cells. The reactions can be carried out in single phase or be diphasic, which is most relevant when the reactants and the product are in different phases.

This invention makes a clean break with conventional batch processes: the double jacketed stirred tank, which is the most frequently used tool, with more than 50% of chemical production units in the world. The engineering of the reactors comprises two key elements: the kinetics of the reactions and the design of the reactors. The design of the reactors must be thought through so that the reaction proceeds at its intrinsic speed, that is to say if there is a perfect mixing and mass transfer in the reactor.

Often, in large, stirred tank reactors, the reaction does not take place at its intrinsic speed because it is limited by the mixing in the tank, that is, the reactants are not perfectly mixed. In this case, it is known that it is “limited by the mixing”. The role of an intensification of the process is to reduce or eliminate these limitations so that the reaction can reach its intrinsic rhythm. Thus, the purpose is to ensure that the mixing and heat/mass transfer rates will be relatively fast with respect to the fundamental kinetics of the process. A high acceleration can be obtained as long as is required by operating in such a rotary system. Transposing chemical syntheses in reactors in which the phases have a piston-like flow, then makes it possible to minimize reaction volumes (safety of installations and operators), to intensify the exchanges of material (mixing, reaction, separation), to regulate and control the temperature with good precision and to add alerting systems in the event of overshoot. Examples include the reduction of benzal-aldehyde to benzyl alcohol by homogeneous ruthenium catalysis, or the two-phase esterification reaction of oleic acid to ethyl oleate by a lipase (Candida Antarca).

Liquid/liquid extraction is a basic operation in the field of process engineering. It consists in passing a solute (the molecule of interest) from a so-called “feed” phase to a so-called “extract” phase. The two phases are immiscible or partially miscible. Many examples exist in the industry, for example the production of antibiotics with an acido-basic extraction cycle.

The invention claimed is:

1. A universal rotor for operations requiring fluids to be subjected to centrifugal accelerations involving the circulation of single-phase or multiphase fluids, for treatments consisting of purifications, extractions, separations, centrifugal partition chromatography (CPC), liquid-liquid extractions, chemical and/or biochemical reactions, the rotor comprising:
(a) one or more discs stacked one on top of the other,
(b) each of said discs comprising a retainer in which a ring, including an assembly of one or more circular sectors, is inserted,
(c) in a case of a single circular sector, a space being provided between two ends of the single circular sector, or
in a case of several circular sectors, said space being arranged between ends of two contiguous circular sectors,
(d) a linking connector is inserted into said space or spaces,
(e) said linking connector including branching channels for a liquid phase entering through inlets into said linking connector to be guided to travel through a network of cells up to outlets of said linking connector, said outlets being in direct contact with inlets of a linking connector of a next disc and so on up to an outlet of a last disc which is connected to an outlet of said rotor.

2. The rotor according to claim 1, formed by a single circular sector comprising a network of successive cells and interconnected by said channels arranged in a plane approximately at a midpoint of its thickness, wherein there is at least one gap between its two ends for arranging in a sealed manner a linking connector, said linking connector comprising at least one inlet and at least one outlet configured to respectively allow entry of a liquid mixture into said network of cells and the exit of said mixture from said network of cells.

3. The rotor according to claim 1, wherein the sectors are formed from a first circular half-sector and a second circular half-sector, each of which is a mirror image of the other, all carrying at their mirror plane half-cells and and half-channels and, the two half-sectors being assembled in a sealed manner face-to-face, to become one circular sector.

4. The rotor according to claim 1, wherein each circular sector of a ring is formed by superposing elements each comprising half cells the sharp edges of which are replaced by chamfers forming rounded surfaces, one against the other.

5. The rotor according to claim 1, wherein the circular sectors are made in one piece, by additive construction.

6. The rotor according to claim 1, wherein a single circular sector comprises, in its thickness, one or more ducts having a generally rectangular cross-section each arranged in a circular pattern, typically three in number, delimited by concentric walls and arranged such that an average radius of each respective circular pattern of ducts substantially corresponds to a same mean radius as that of a corresponding circular pattern of a network of cells, for circulating a temperature control or thermostatting fluid in said ducts in an identical manner for each one of said networks of cells.

7. The rotor according to claim 1, the wherein said linking connector comprises said branches so that said temperature control or thermostatting fluid entering through an inlet passes through all of said ducts connected in series of each one of said circular sectors constituting said ring and then, guided by said linking connector, passes to a linking connector of a next adjacent disc of said stack and so forth up to an outlet of said rotor.

8. The rotor according to claim 1, wherein a linking connector comprises said branches so that said temperature control or thermostatting fluid entering through an inlet passes through all of said ducts connected in series of each one of a number of circular sectors constituting said ring and then, guided by said linking connector, passes to a linking connector of a next adjacent disc of the stack and so forth up to an outlet of said rotor.

9. The rotor according to claim 1, wherein said linking connector also includes an inlet and an outlet allowing entry and exit of a temperature control or thermostatting fluid in order for it to pass through said at least one temperature control or thermostatting fluid duct.

10. The rotor according to claim 1, wherein said cells have walls provided with fins.

11. The rotor according to claim 1, wherein said linking connector comprises at least one inlet and at least one outlet for respectively allowing entry of a liquid mixture into said networks of cells and an exit of said mixture from the networks of cells, such that between said outlet and said inlet, said liquid phase passes through all the cells and channels of a respective disc.

12. The rotor according to claim 1, wherein when said linking connector is a non-static connector, in this case a single or multi-way valve comprising “ON” and “BYPASS positions is added thereto, making it possible to select positions such that in the “ON” position of said valve a said liquid phase entering at said inlet is directed to an outlet of said valve to then enter said inlet of a contiguous circular sector in order to traverse said entire network of cells of said disc and arrive at said outlet of a last circular sector and then to said inlet) and then to said outlet of said linking connector, to enter a next contiguous of said disc at said inlet of said linking connector thereof but, if a ball of said valve is in said “BYPASS” position, said liquid phase entering at said inlet is directed directly to said outlet without traversing said cells of said disc concerned, the latter being short-circuited, allowing a user to adjust a number of said cells to each of its various applications in steps by said number of said cells contained in said disc.

13. The rotor according to claim 1, wherein, “n” first cells of said rotor have decreasing volumes according to a determinable function ranging from (V7) to (V) with (V7>V), V being a constant volume of most of said cells of said rotor, thereby increasing the productivity of said rotor, in CPC mode, in an ascending mode.

14. A method of using a universal rotor, in an apparatus, the method comprising:
circulating one or more liquids submitted to stable and adjustable centrifugal accelerations, at high pressures and at temperatures able to be varied with short time constants,
said apparatus being a chemical and/or biochemical reactors and/or for extractions, separations and purification in centrifugal partition chromatography (CPC), the fluids comprising organic or non-ionic liquids, ionic liquids, CO₂ in liquid or supercritical phase,
using said rotor of said apparatus, which includes one or more discs stacked one on top of the other, each of said discs including a retainer in which a ring is inserted into an assembly of one or more circular sectors,
providing a space between ends of a single circular section for a single circular sector or arranging said space between said ends of said contiguous circular sectors for several circular sectors, and
inserting a linking connector into said space or spaces, and directly contacting outlets of a linking connector with inlets of another linking connector of a next of said discs, said linking connectors having branching channels to cause a liquid phase entering through inlets to be guided to travel through a network of cells to outlets.

15. The method of using the universal rotor according to claim 14, in operations requiring fluids to be subjected to said centrifugal accelerations requiring said circulation of single-phase or multiphase fluids, for said purifications, extractions, separations, centrifugal partition chromatography (CPC), liquid-liquid extractions.

16. The method of using the universal rotor according to claim 14, in operations requiring fluids to be subjected to said centrifugal accelerations requiring said circulation of single-phase or multiphase fluids, for chemical and biochemical reactions.
